(19) United States
(12) Patent Application Publication
(10) Pub. No.: US 2002/0169351 A1
(43) Pub. Date: Nov. 14, 2002

(54) Remediation of radioactive waste by stimulated radioactive decay

(76) Inventor: Paul M. Brown, Meridian, ID (US)

Correspondence Address: PEDERSEN & COMPANY, PLLC, INTELLECTUAL PROPERTY LAW, 1410 N. 28th St. (83703), Post Office Box 2666, Boise, ID, 83701-2666, US

(21) Appl. No.: 09/877,624

(22) Filed: Jun. 8, 2001

Related U.S. Application Data
(63) Continuation-in-part of application No. 09/105,313, filed on Jun. 26, 1998, now abandoned.

(51) Int. Cl. G21F 9/00

(52) U.S. Cl. 588/1

(57) ABSTRACT

Disclosed is a radioactive waste treatment process for transmuting long-lived radioisotopes into short-lived radioisotopes through applied nuclear physics. Nuclear reactions, specifically of the (γ, n) type, also known as photodisintegration, are utilized to accomplish this transmutation from troublesome, long-lived radioactive waste isotope(s) of given atomic mass to shorter-lived or stable materials of lower atomic mass, by exposing the troublesome isotopes to a high energy photon flux for a sustained time. Generally speaking, the target nucleus of the radioisotope(s) to be treated is irradiated by gamma photons of an energy greater than the binding energy of the neutron in the target nucleus. This causes the irradiated nucleus to absorb the gamma rays, thereby placing the nucleus in an excited state. Upon relaxation, the nucleus ejects a neutron through the (γ, n) reaction, thereby transmuting the element to an isotope of lower atomic mass and shorter half-life.

### DESCRIPTION

This application is a continuation-in-part of, and claims priority from, prior co-pending application Ser. No. 09/105,313, entitled “Photo-Remediation of Radioactive Waste by Stimulated Radioactive Decay,” filed Jun. 26, 1998.

### BACKGROUND OF THE INVENTION

1. Field of the Invention

Embodiments of the present invention relate to a method for accelerating the decay of radioactive waste products, and more particularly they relate to nuclear transmutation of heavy radioactive elements into lighter ones with shorter half-lives. The invented process therefore relates to reducing long-term toxicity of radioactive waste and to, an economic and effective process facility for doing so.

2. Related Art

The present invention relates to a method for photon excitation of nuclear reaction/transmutation processes, thereby accelerating the decay of radioactive waste products. More particularly, the present invention relates to a method of accelerating the decay of radioactive isotopes, which method comprises bombarding radioactive atoms with X-rays, gamma rays, electrons or high-energy photons, and thereby assisting in the deactivating or neutralizing of radioactive waste.

U.S. Pat. No. 3,974,390 entitled “Method of Producing Excited States of Atomic Nuclei” issued to Masato Morita on Aug. 10, 1976, discloses a method of producing excited atoms by using x-rays to knock electrons from the K shell. When another electron falls into the vacant K shell, the energy is imparted to the nucleus thereby exciting the nucleus which relaxes by gamma or beta emission. This is an indirect method of imparting energy to the nucleus of an atom.

U.S. Pat. No. 4,961,880 entitled “Electrostatic Voltage Excitation Process and Apparatus” issued to William Barker on Oct. 9, 1990, discloses a process and apparatus for utilizing electrostatic charge to lower the Coulomb barrier thus reducing the energy required for the nucleus to expel an alpha particle, thereby accelerating the decay rate of the radioisotope. Electrostatic fields are generally not of sufficient energy to effect nuclear reactions as they are defined herein.

U.S. Pat. No. 5,076,971 entitled “Method of Enhancing Alpha Decay in Radioactive Materials” issued to William Barker on Dec. 31, 1991, discloses a method and apparatus for decontaminating radioactive materials by accelerating the decay rate by electrostatic means. Electrostatic fields are generally not of sufficient energy to effect nuclear reactions as they are defined herein.

Each of the above-cited U.S. patents describe a method for effecting the decay rate of radioisotopes, yet none of them have seen practical application.

At present, there are four industrially-demonstrated separations processes that are applicable in the present invention to separate radioactive isotopes from nuclear waste. These processes are designed primarily for the concentration and purification of plutonium, but only the PUREX™ process is well established in current worldwide use. In the past, the British have used a solvent extraction process called BUTEX™, the French have used ion exchange, and there have been a number of ion exchange processes that have had limited production use in the isolation of minor actinides. Several potentially applicable separations processes based on new solvents, such as the TRUEX-CMPO™ process, and new ion exchange materials are in various conceptual or laboratory scale development stages. Such advanced aqueous processes have been proposed to achieve high decontamination factors but have not been demonstrated at the full engineering pilot-plant level.

What is still needed, then, is an effective method for remediation of radioactive waste by stimulated radioactive decay. What is still needed is a process facility for effectively performing this remediation, with efficient use of the by-products of the remediation.

### SUMMARY OF THE INVENTION

Several objects of the present invention focus on finding a practical, economic, and safe way of remediating radioactive waste that may comprise a mixture of long-half-life isotopes. The preferred methods comprise making the radioisotopes more active, but shorter-lived. More specifically, it is an object of the present invention to provide a method of transmuting radioactive atomic nuclei through a nuclear process in a comparatively simple manner. The present invention may be used with high-toxicity, radioisotopes with atomic Z number greater than 50, which are the isotopes of principal concern in waste disposal. It is another object of the present invention to provide a method of transmuting radioactive isotopes by bombarding atoms with X-rays, gamma rays, electrons or high-energy photons. It is still another object of the present invention to provide a method and apparatus to stimulate decay of radioactive materials rapidly enough for it to be of practical value in disposing of radioactive wastes in storage.

The invented process may be used for treating long-lived radioisotopes and transmuting them into short-lived radioisotopes through applied nuclear physics. Nuclear reactions, specifically of the gamma, neutron type, written as (γ, n), which are also known as photodisintegration, are utilized to accomplish this transmutation from a radioisotope of given atomic mass to that of lower atomic mass. Photodisintegration usually gives rise to neutron emission, i.e., to a gamma, neutron (γ, n) reaction, by the nuclei which have been raised to excited states by the absorption of photons. In the preferred embodiment of the invention, this neutron emission may be used for bombardment of other radioisotopes.

Generally speaking, the target nucleus of the radioisotope to be treated is irradiated preferably by gamma photons of an energy greater than the binding energy of the neutron in the target nucleus, thereby causing the ejection of said neutron through the (γ, n) reaction. That is to say, a radioactive element is exposed to high-energy photons preferably in the form of gamma rays. These gamma rays are absorbed by the target nucleus, placing it in an excited state. Upon relaxation, the nucleus ejects the neutron, thereby transmuting the element to an isotope of lower atomic mass. This ejection may also be called “knocking” a neutron from a nucleus or expelling, or emitting a neutron.

The processes of the present invention may be performed in a process facility including an accelerator for producing the desired flux of photons, a reactor system for containing the radioactive isotopes to be gamma-treated and preferably also the radioactive isotopes to be treated by the neutron emissions from the transmuting gamma-treated isotopes. In addition, appropriate controllers are preferably included, such as those that monitor progress of the transmutation, recharge the reactor system with radioactive materials, and control utilization of the heat produced from the transmutation.

Other objects, features and advantages of the present invention will become apparent from the following description and drawings.

### BRIEF DESCRIPTION OF THE DRAWINGS

FIG. 1 illustrates partial and total photonuclear cross sections for U²³⁸.

FIG. 2 illustrates total photonuclear cross sections for Th²³², U²³⁸ and Np²³⁷.

FIGS. 3 (A and B) illustrate total photonuclear cross sections for, U²³⁶ and Pu²³⁹

FIG. 4 is a graph which summarizes experimental data on photonuclear cross-sections integrated to 30 MeV as a function of Z.

FIG. 5 is a schematic diagram representing a commercial waste transmutation process according to an embodiment of the invention.

FIG. 6 is a detail schematic diagram representing one embodiment of the chemical separation section of FIG. 5.

### DESCRIPTION OF THE PREFERRED EMBODIMENTS

In accordance with the present invention, therefore, there is provided a method of producing unstable atomic nuclides, which method comprises the bombarding of atoms with high energy, such as X-rays, gamma rays, electrons, or high-energy photons. When the energy of bombarding gamma rays, for example, is greater than the binding energy of a neutron to the target nucleus, and the nucleus is excited by this energy absorption from its ground state to an excited state, then a neutron is ejected from the nucleus upon its relaxation from the excited state. This process is called “stimulated radioactive decay.” The process transmutes unstable isotopes by using photon bombardment to release neutrons from atomic nuclei, thus transmuting isotopes to isotopes of less atomic mass. When neutrons are released, the resulting isotopes have a considerably shorter half-life and decay to stable forms in shorter amounts of time. Generally speaking, in most cases, the photodisintegration of a radioisotope results in a product of increased specific activity, the greater specific activity that a radioisotope has, the shorter the half-life of the radioisotope is expected to be.

While gamma rays are preferred for the bombardment of the long-half-life radioisotopes, various forms of high energy may be used, for example, X-rays, electrons, or high-energy photons. While gamma rays are generally of a higher energy spectrum than x-rays, the energy spectrum of gamma rays and x-rays overlap in the region of Giant Dipole Resonance and this is the region of specific interest for the present invention. The Microsoft Encarta Encyclopedia 2000 states, “The shorter the wavelength of the x-ray, the greater is its energy and its penetrating power. Longer wavelengths, near the ultraviolet-ray band of the electromagnetic spectrum, are known as soft x-rays. The shorter wavelengths, closer to and overlapping the gamma ray range, are called hard x-rays.” Vendors sell industrial and medical x-ray equipment with energies up to 10 MeV. NIST (previously national Bureau of Standards) lists x-rays with an energy from 1 KeV to 20 MeV and gamma rays from 1 MeV to 100 GeV. In the range of Giant Dipole Resonance (5 MeV to 15 MeV) the published literature can cite many references using gamma rays, x-rays and high energy photons synonymously.

Giant Dipole Resonance is described and discussed more fully as follows:

The classical description of the dipole photon absorption process predicts that for spherical nuclei the total photon-absorption cross section is characterized by the Lorentz line shape,

σ(Ε_{γ})=σₘ /[1+(Ε_{γ}²−Εₘ²)²/Ε_{γ}² Γ²]

where Εₘ is the peak cross section, Εₘ is the resonance energy, and Γ is the full width at half maximum. For deformed (spheroidal) nuclei, the collective picture predicts a splitting of the giant resonance into two components, corresponding to oscillations parallel and perpendicular to the nuclear axis of symmetry.

For medium and heavy nuclei, the Coulomb barrier inhibits the emission of charged particles at giant-resonance energies, and the photon-scattering cross section is always small above the (γ,n) threshold; therefore, the total photoneutron cross section is a good approximation to the total photon-absorption cross section.

The intrinsic quadrupole moment Qₒ for a deformed nucleus can be computed from the expression,

Qₒ=2/5ZR²ε=2/5ZR²(η−1)η^{-2/3}

Where the nuclear radius R=RₒA/^{⅓}, Z and A are the atomic number and atomic weight, respectively, ε is the nuclear eccentricity, and the parameter η is the ratio of the major axis to the minor axis (for the prolate nucleus) given by the formula,

Ε_{m (}2)/Εₘ(1)=0.911η+0.089,

Where Εₘ (1) and Εₘ (2) are the lower and higher resonance energies of a two-component Lorentz-curve fit to the giant resonance.

The characteristics of the giant dipole resonance for the actinide nuclei are of particular interest. For such high-Z, high-Coulomb barrier nuclei, the total photon-absorption cross section is equal to the sum of the photoneutron and photofission cross sections. The total photoneutron cross section is the sum of the following reaction cross sections,

σ(γ, nₜₒₜ)=Ε(Ε,n)+2σ(Ε,2n)+νσ(Γ,f) (Eq. 1)

where ν is the neutron multiplicity of a fission event. The total neutron production cross section is then,

σΕ, N=σ_{Ε, n}+νσ_{Ε, f} (Eq. 2)

The competition between neutron emission and fission may be expressed,

Γn/Γf(Ε)=σ(γ, n)/σ(γ, f)(γ) (Eq. 3).

The value for Γn/Γf decreases exponentially with the fissility of the nuclei (ref 8). The theoretical expression for Γn/Γf which explains this behavior for the neutron emission and fission competition is derived from the Constant Nuclear Temperature for the level density, and is expressed.

Γn/Γf=2 TA^{⅔}/10exp{(Ef−Bn′)/T} (Eq. 4)

where (Ef−Bn′) are the effective thresholds for the respective photonuclear processes and T is the nuclear temperature.

The fact that more than one neutron is emitted per fission in the fission of such isotopes as Th²³², U²³³, U²³⁵, U²³⁸, and Pu²³⁹ leads to the possibility of a chain reaction in a mass of fissionable material. Whether the chain reaction remains steady, builds up, or dies down depends upon the competition between the production of neutrons through fission and the loss of neutrons through a variety of processes such as non-fission capture of neutrons, primarily (n,γ) reactions in the system, and the leakage of neutrons through the surface of the system.

In a light-water nuclear reactor energy is released at the rate of 200 MeV per fission of one atom or about 23×10⁶ kw-hr per fission of one kilogram of U²³⁵. The fission fragments carry off 82% of the energy in the form of kinetic energy. Prompt neutrons carry off another 2.5%, prompt gammas carry off 3.5%, beta decay accounts for 4%, delayed gammas account for 3%, and neutrinos carry off the remaining 5%. The neutrinos and their energy are lost, since the probability of interaction with neutrinos is so small. Some fission also occurs as a fast neutron strikes a U²³⁵ atom. Also, as the fuel is burned, plutonium is produced, and by the end of a fuel cycle (18 months of operation), 35% of the energy is actually coming from the fission of Pu²³⁹ atoms. About 80% of the neutron absorption in U²³⁵ results in fission; the other 20% are (n,γ) reactions.

Once a fission chain reaction is started, the effective multiplication factor kₑ will determine whether the chain reaction will continue at a steady rate, increase, or decrease. The effective multiplication factor is defined as the ratio of the rate of production of neutrons, P, to the combined rate of absorption A and the rate of leakage L of neutrons, or kₑ=P/A+L. The term absorption includes all types of absorption, such as those which produce fission and those which produce (n,γ) processes in the material of the reactor. The fission chain reaction will be critical or steady when kₑ=1, it will be building up or supercritical when kₑ>1, and it will be dying down or subcritical when kₑ<1.

If F is the rate at which fission processes occur, and if v is the average number of neutrons emitted per fission, then P=νF. Then we may write kₑ=P/A+L as kₑ=νF/A+L from which we get

kₑ=ν(F/A)[1/1+(L/A)] (Eq. 5).

The ratio F/A depends upon the amount of fissionable and nonfissionable material and on their cross sections for fission and neutron capture. The ratio L/A depends upon the ability of the reactor to contain and absorb neutrons before they can escape through the surface. As the size of a reactor decreases, the rate of neutron leakage through the surface increases, and the rate of neutron absorption decreases, so that L/A increases and approaches infinity, and hence in the limit kₑ approaches zero. As the size of the reactor increases, L/A decreases toward zero, and kₑ increases toward the limiting value νF/A. Hence if the composition of the reactor is such that νF/A>1, then there is some size of this reactor for which kₑ=1; for this size, the reactor is critical. This size is called the critical size and the mass of fissionable material at this size is called the critical mass. The region containing the fissionable material is called the reactor core. The core may be surrounded by nonfissionable material capable of reflecting neutrons back into the core; in such a case both the critical size and the critical mass are reduced. On the other hand, if there is an insufficient amount of fissionable material or an excess of absorbing material in the reactor core so that νF/A<1, then there is no size for which a steady chain reaction can occur, irrespective of whether or not a reflector is used. Pure natural uranium, no matter how large the amount, cannot support a chain reaction, that is νF/A<1.

Titterton (1950) found that the average kinetic energy released in the photofission of Th²³² is about 0.8 of that released in the slow-neutron fission of U²³⁵ or about 160 MeV.

TABLE I
Thermal Neutron Cross Sections For Uranium

| | Cross Section (Barns) | | |
|---|---|---|---|
| Process | U²³⁵ | U²³⁸ | U^{natural} |
| Fission | 549 | 0 | 3.92 |
| n-Capture | 101 | 2.80 | 3.5 |
| Scattering | 8.2 | 8.2 | 8.2 |

TABLE II
Fission Threshold Energy of Select Isotopes

| | PHOTOFISSION | NEUTRON-FISSION |
|---|---|---|
| NUCLIDE | THRESHOLD (MeV) | THRESHOLD (MeV) |
| Am²⁴¹ | 6.0 | — |
| Am²⁴² | — | 6.4 |
| Th²³² | 5.8 | 1.3 |
| Np²³⁷ | 5.6 | 0.4 |
| Np²³⁸ | — | 6.0 |
| U²³³ | 5.7 | 0.025 |
| U²³⁴ | 6.0 | 0.4 |
| U²³⁵ | 5.3 | 0.025 |
| U²³⁶ | — | 0.8 |
| U²³⁷ | — | 6.3 |
| U²³⁸ | 5.8 | 1.2 |
| Pu²³⁹ | 5.8 | 0.025 |

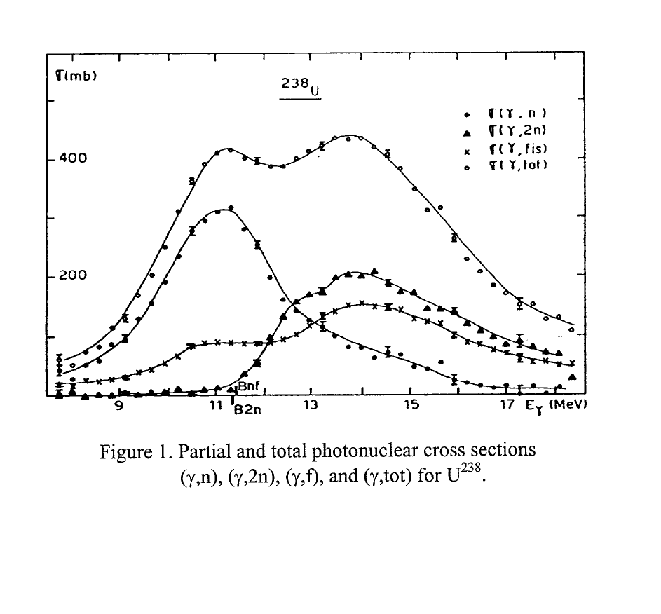

### FIG. 1. Partial and total photonuclear cross sections (γ,n), (γ,2n), (γ,f), and (γ,tot) for U²³⁸.

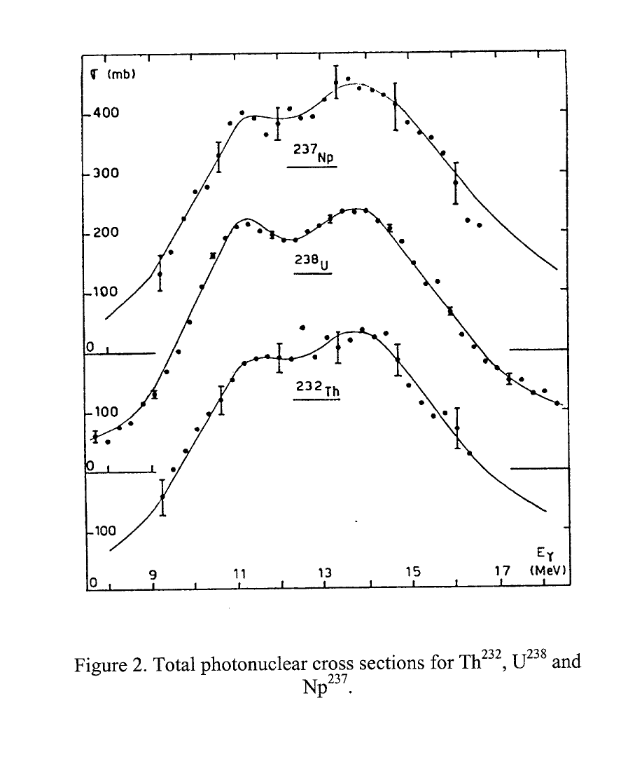

FIG. 1 shows the photonuclear cross sectional data for U238. Notice that the total photonuclear cross sections all have about the same peak cross section value. The maximum cross sections are all about 0.5 b and all are about 6 MeV wide, this appears to hold true for all the actinides. The photo-absorption cross section falls sharply above the (γ,2N) and (γ,nf) peaks, as is the case for essentially all medium and heavy nuclei as provided by the examples in FIG. 2.

The thermal fissionable nuclides include Np²³⁸, Pa²³², Pu²³⁹, Pu²⁴¹, Th²²⁷, U²³¹, U²³³, U²³⁵. All those nuclides fissionable by thermal neutrons are, of course, also fissionable by fast neutrons. In addition, there are several nuclides such as U²³⁸, Th²³², Pa²³¹, and Np²³⁷ which are fissionable by neutrons having energies of about 1 MeV.

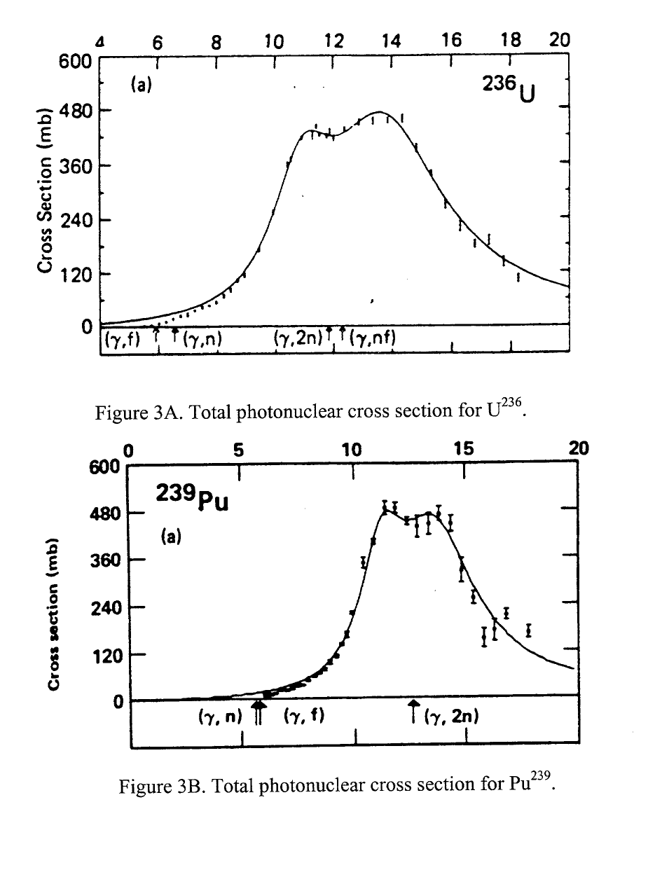

Looking at FIGS. 1 through 3 we see that at 10 MeV the (γ,n) reaction is about three times the (γ,ƒ) reaction. Table IV lists several (γ,n) reactions that result in the neutralization or burn-up of the radioisotope resulting in stable, non-radioactive products.

The reactions that occur within the accelerator driven reactor are too numerous to list but the most important reactions are shown in Table IV.

TABLE III
Fissionabilities

| | | σᵢₙₜ(γ, F) | |
|---|---|---|---|
| Nucleus | Z²/A | σᵢₙₜ(γ, tot) | Γₙ/Γ_{f} |
| Th²³² | 34.91 | 0.11 | 15 |
| U²³⁸ | 35.56 | 0.30 | 3.9 |
| U²³⁶ | 35.86 | 0.46 | 2.1 |
| U²³⁵ | 36.02 | 0.62 | 1.4 |
| U²³⁴ | 36.17 | 0.68 | 0.99 |
| U²³³ | 36.33 | 0.81 | 0.49 |
| Np²³⁷ | 36.49 | 0.60 | 0.68 |
| Pu²³⁹ | 36.97 | 0.74 | 0.62 |

In a (γ, n) reaction neither the γ-ray nor the neutron has a Coulomb barrier to surmount, so reaction sets in sharply as soon as the threshold energy is reached.

For many Fission products the neutron capture cross sections in a thermal spectrum can give substantial transmutation rates. The transmutation of Tc⁹⁹ is characteristically much more effective in a thermal neutron spectrum generally due to higher neutron capture cross section at lower energies.

The systematics of the giant dipole resonance which characterizes the absorption of electromagnetic radiation by nuclei in the energy range from about 5 to 30 MeV, have been of interest since the discovery of the giant resonance itself. Over the years, the photoneutron cross sections for many nuclei have been measured with monoenergetic photons in numerous laboratories. All these data are presented in the Atomic Data Nuclear Data Tables. For most cases studied, the agreement is remarkably good.

TABLE IV
Relevant Reactions in PCT/US99/14271

PHOTOFISSION REACTIONS:
(γ,ƒ): U²³⁸, Th²³², Pa²³¹, Np²³⁷, Np²³⁸, Pa²³², Pu²³⁹, Pu²⁴¹, Th²²⁷, U²³¹, U²³³, U²³⁵.
FISSION REACTIONS: (just one of many)
₉₂U²³⁵ + ₀n¹ → ₃₈Sr⁹⁴ + ₅₄Xe¹⁴⁰ + 2₀n¹
₃₈Sr⁹⁴ → ₃₉Y⁹⁴ + β⁻ → ₄₀Zr⁹⁴ + β⁻ (stable)
₅₄Xe¹⁴⁰ → ₅₅Cs¹⁴⁰ + β⁻ → ₅₆Ba¹⁴⁰ + β⁻ → ₅₇La¹⁴⁰ + β⁻ → ₅₈Ce¹⁴⁰ + β⁻ (stable)
(γ,n) ENRICHMENT:
₉₂U²³⁶ + γ → ₉₂U²³⁵ + ₀n¹
₉₂U²³⁸ + γ → ₉₂U²³⁶ + 2₀n¹ + γ → ₉₂U²³⁵ + ₀n¹
₉₅Am²⁴¹ + γ → ₉₅Am²⁴⁰ + ₀n^{1 +} ₋₁e⁰ → ₉₄Pu²⁴⁰
₉₃Np²³⁷ + γ → ₉₃Np²³⁵ + 2₀n¹ + −1e⁰ → ₉₂U²³⁵
₉₂U²³⁸ + γ → ₉₂U²³⁷ + ₀n¹ + γ → ₉₂U²³⁶ + ₀n¹ + γ → ₉₂U²³⁵ + ₀n¹
₉₄Pu²³⁸ + γ → ₉₄Pu²³⁶ + 2₀n¹ + γ → ₉₄Pu²³⁵ + ₀n¹ + ₋₁e⁰ → ₉₃Np²³⁵ + ₋₁e⁰ → ₉₂U²³⁵
₉₂U²³⁸ + γ → ₉₂U²³⁷ + ₀n¹ → ₉₃Np²³⁷ + β⁻ + γ → ₉₃Np²³⁵ + 2₀n¹ + ₋₁e⁰ → ₉₂U²³⁵
₉₄Pu²³⁹ + γ → ₉₄Pu²³⁷ + 2₀n¹ + γ → ₉₄Pu²³⁵ + 2₀n¹ + ₋₁e⁰ → ₉₃Np²³⁵ + ₋₁e⁰ → ₉₂U²³⁵
₉₄Pu²³⁹ + γ → ₉₂U²³⁵ + α
NEUTRON ENRICHMENT:
₉₂U²³⁴ + ₀n¹ → ₉₂U²³⁵ + γ
₉₂U²³⁸ + ₀n¹ → ₉₂U²³⁹ + γ → ₉₃Np²³⁹ + β⁻ → ₉₄Pu²³⁹ + β⁻
₉₀Th²³² + ₀n¹ → ₉₀Th²³³ + γ → ₉₁Pa²³³ + β⁻ → ₉₂U²³³ + β⁻
(γ,n) NEUTRALIZATION:
₁H³ + γ → ₁H² + ₀n¹ (stable)
₆C¹⁴ + γ → ₆C¹³ + ₀n¹ (stable)
₃₉Y⁹⁰ + γ → ₃₉Y⁸⁹ + ₀n¹ (stable)
₂₈Ni⁶³ + γ → ₂₈Ni⁶² + ₀n¹ (stable)
₃₆Kr⁸⁵ + γ → ₃₆Kr⁸⁴ + ₀n¹ (stable)
₂₇Co⁶⁰ + γ → ₂₇Co⁵⁹ + ₀n¹ (stable)
₈₁Tl²⁰⁴ + γ → ₈₁Tl²⁰³ + ₀n¹ (stable)
₃₈Sr⁹⁰ + γ → ₃₈Sr⁸⁸ + 2₀n¹ (stable)
₈₃Bi²¹⁰ + γ → ₈₃Bi²⁰⁹ + ₀n¹ (stable)
₅₆Ba¹³³ + γ → ₅₆Ba¹³² + ₀n¹ (stable)
₈₂Pb²¹⁰ + γ → ₈₂Pb²⁰⁸ + 2₀n¹ (stable)
₃₈Sr⁹⁰ + γ → ₃₈Sr⁸⁹ + ₀n¹ → ₃₉Y⁸⁹ + β⁻ (stable)
₅₃I¹²⁹ + γ → ₅₃I¹²⁸ + ₀n¹ → ₅₄Xe¹²⁸ + β⁻ (stable)
₅₅Cs¹³⁷ + γ → ₅₅Cs¹³⁶ + ₀n¹ → ₅₆Ba¹³⁶ + β⁻ (stable)
₂₆Fe⁶⁰ + γ → ₂₆Fe⁵⁹ + ₀n¹ → ₂₇Co⁵⁹ + β⁻ (stable)
₈₂Pb²¹⁰ + γ → ₈₂Pb²⁰⁹ + ₀n¹ → ₈₃Bi²⁰⁹ + β⁻ (stable)

Steps involved in the preferred process of stimulated radioactive decay are as follows: First, the radioactive isotopes are separated from radioactive waste by well known chemical processes. Then, electrons are accelerated in an accelerator, such as a linear accelerator or a betatron, to impact a high-Z target, such as a tungsten or titanium target. This impacting of a high-Z target generates the high energy gamma rays, which are then directed at the nucleus of the radioactive isotope to be remediated. This gamma ray bombardment causes the nucleus to emit a neutron, which may for convenience be called “knocking” a neutron, from the nucleus of the radioactive isotope atom, as described above.

In the prior art, a bombardment process has been used to produce neutrons, but using different materials and resulting in different products than the invented process. In the prior art bombardment process, a stable, non-radioactive atom is typically subjected to bombardment, and a neutron is ejected from the nucleus. From this prior art bombardment process, the neutron is the desired product and the atom minus the neutron is a radioactive waste product.

In contrast to the prior art bombardment process, the method of the present invention subjects an unstable, radioactive atom to bombardment, resulting in a neutron being ejected from the nucleus. The resulting atom minus the neutron is a product more radioactive and with a shorter half-life than the radioactive starting material, and the neutron is a by-product.

An example of half-life reduction that may be accomplished according to the invention is cesium-137 with a half-life of 30.17 years being transformed into cesium-136 with a half-life of 13 days. Long-lived daughter products may be treated in the same manner. These and other examples of processes according to the current invention are listed in the following Table 5:

TABLE 5

H³ (γ, n) H² (stable)
C¹⁴ (γ, n) C¹³ (stable)
Y⁹⁰ (γ, n) Y⁸⁹ (stable)
Ni⁶³ (γ, n) Ni⁶² (stable)
Kr⁸⁵ (γ, n) Kr⁸⁴ (stable)
Co⁶⁰ (γ, n) Co⁵⁹ (stable)
Tl²⁰⁴ (γ, n) Tl²⁰³ (stable)
Sr⁹⁰ (γ, 2n) Sr⁸⁸ (stable)
Bi²¹⁰ (γ, n) Bi²⁰⁹ (stable)
Tl²⁰⁴ (γ, n) Tl²⁰³ (stable)
Ba¹³³ (γ, n) Ba¹³² (stable)
Pb²¹⁰ (γ, 2n) Pb²⁰⁸ (stable)
Sr⁹⁰ (γ, n) Sr⁸⁹ (50 day half-life) - β⁻ → Y⁸⁹ (stable)
Tc⁹⁹ (γ, 3n) Tc⁹⁶ (4.3 day half-life) - β⁻ → Ru⁹⁶ (stable)
I¹²⁹ (γ, n) I¹²⁸ (25 minute half-life) - β⁻ → Xe¹²⁸ (stable)
Cs¹³⁷ (γ, n) Cs¹³⁶ (13 day half-life) - β⁻ → Ba¹³⁶ (stable)
Fe⁶⁰ (γ, n) Fe⁵⁹ (44.5 day half-life) - β⁻ → Co⁵⁹ (stable)
Pb²¹⁰ (γ, n) Pb²⁰⁹ (3.25 hour half-life) - β⁻ → Bi²⁰⁹ (stable)

Examples of sources of high energy photons for photodisintegration of atomic nuclei include gamma rays of one energy, or gamma rays from a source which yields a continuous spectrum of energies, such as Bremsstrahlung, including a high-voltage X-ray tube or a betatron. For example, the best known gamma, neutron reaction is the photodisintegration of the deuteron,

₁H²+γ→1¹+0n¹

In the short-hand typically applied to reactions, if the “Q” of a reaction is negative, kinetic energy is converted to mass in an endothermic reaction. A negative Q value therefore means that kinetic energy must be brought into the nucleus to make the reaction proceed. An example is a reaction that cannot proceed until a photon brings in enough energy to a nucleus to satisfy conservation of energy. This means, in layman's terms, that the extent of the gamma reaction, or, in the terms of the art, that the “cross section” for a gamma reaction is 0 until the energy of the projectile is at least equal to Q. The energy of the projectile at which the reaction first has a non-zero cross section is called the “threshold” energy for the reaction. The threshold of the reaction is that energy of the gamma ray which is just sufficient to break the proton-neutron bond; i.e., the gamma ray must deliver an energy equal to or greater than the binding energy of the nucleon to affect the photodisintegration reaction.

When describing the reactions of the instant invention, one may use the equation R=σΦN, in which R is the reaction field, σ is the nuclear cross-section, Φ is a constant characteristic of the nuclear reaction in question, and N is the number of target atoms. The equation term σ has the dimensions of an area, and is therefore usually called the “cross-section” of the reaction. The number of photons per square centimeter per second incident on a target is called the “flux.” When a target is exposed to a flux of photons, the number of nuclei reacting is proportional to the flux, and to the number, N, of target atoms. We can picture each target atom as having a disk of area σ, with reaction occurring every time an incident photon strikes the disc. In some circumstances, σ is indeed equal to the physical cross-section of the nucleus. Tables and graphs of photonuclear cross-sections exist and may be used to calculate reaction yields. In such tables σ is usually expressed in barns or millibarns, one barn being 10⁻²⁸ m². Cross-sections vary with the energy of the incident photon, and the tables usually indicate this variation. Where there is a threshold energy, σ is 0 below the threshold but σ rises to positive values above the threshold. The relation between cross-section and energy is called the “excitation function” of the process.

Therefore, the energy of the gamma ray for which neutrons are first observed to be ejected is the binding energy of the neutron. Baldwin and Koch (1945) were able to determine the threshold for photodisintegration of several different stable nuclei in the range of atomic numbers Z=6 to Z=47. Sher, Halpern, and Mann determined the threshold of many (γ, n) reactions. The threshold value of the (γ, n) reaction with any isotope of mass number A corresponds to the binding energy of the neutron in the nucleus of the isotope of mass number (A-1)

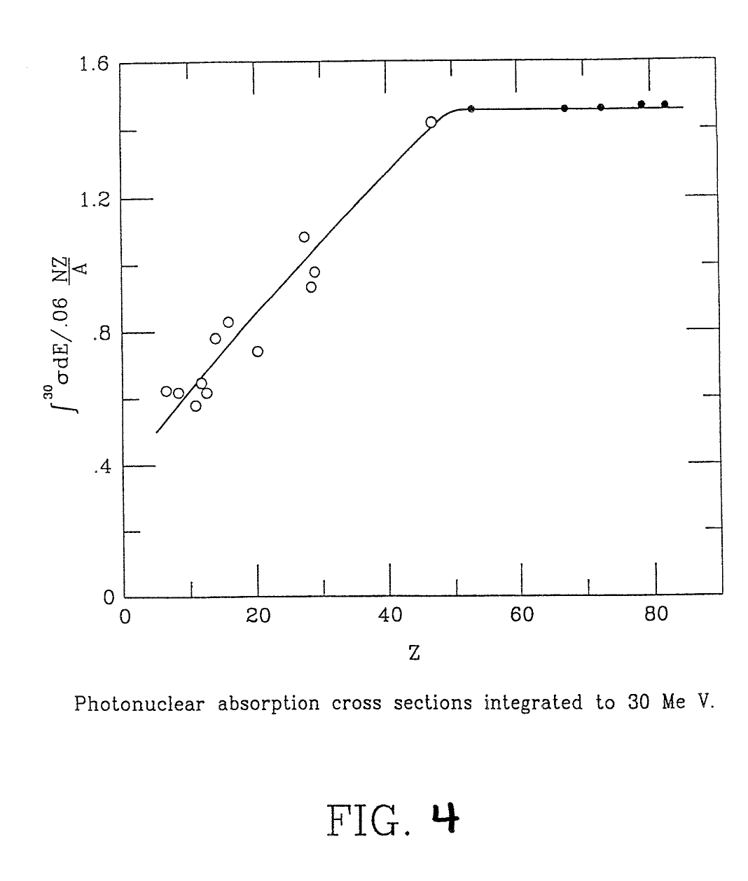

The (γ, n) cross-section is very large for most nuclei for gamma energies between 10 and 20 MeV. This effect, called the “giant resonance,” is responsible for much of the neutron background of high-energy gamma ray machines. The giant resonance occurs in all nuclei and is viewed as a general property of nuclei. Its width is 3-10 MeV and it is located between 13 and 18 MeV for medium stable elements and heavy stable elements, namely Z≧16, and near 20 MeV for light stable elements, namely Z≦16. FIG. 4 summarizes experimental data on the photonuclear cross-sections integrated to 30 MeV as a function of Z for stable isotopes. FIG. 4 shows that nuclei with atomic number Z greater than 50 have the largest absorption cross-sections. FIG. 4 indicates the minimum energy needed to eject a neutron is less than about 30 MeV. Therefore, this amount of energy, that is, less than about 30 MeV, is the amount of energy required to use the preferred method of the subject invention.

Table 6 shows a list of useful neutron capture gamma rays and their relative intensities.

TABLE 6

| | | γ-rays/neutron |
|---|---|---|
| Element | E (MeV) | capture* |
| | 5.44 | 0.038 |
| Hg | 6.12 | 0.177 |
| Cl | 7.28 | 0.042 |
| Fe | 7.49 | 0.029 |
| Co | 7.64 | 0.30 |
| Fe | 7.73 | 0.22 |
| Al | 7.82 | 0.06 |
| Ni | 7.91 | 0.20 |
| Cu | 8.449 | 0.06 |
| Cr | 8.56 | 0.021 |
| Cl | 8.881 | 0.14 |
| Cr | 8.997 | 0.27 |
| Ni | 9.30 | 0.024 |

*The errors on these intensities are of the order of ±30 percent.

Not present in Table 6 are the useful neutron capture gamma rays and their relative intensities for the radioactive elements of the present invention, that is, for the radioactive elements remediated by this invention. This is because, to the knowledge of the instant inventor, such experimental work has not yet been done. However, the inventor envisions that such experimentation may be done for the radioactive elements in the same general way it was done for the listed non-radioactive elements. The inventor expects the amounts for the radioactive elements of the present invention to be about 5 to 14 MeV.

The core excitation model of the nucleus, or the “weak-coupling model,” is a model involving electromagnetic properties of the nucleus. The core excitation model is a textbook model used to describe nuclear activities, which is accepted as having a high degree of validity in the nuclear science community. This is a model devised for the description of low lying states of odd-A nuclei, which tries to relate such properties to those of the odd particle and the even-even core. In other words, a state of an odd-A nucleus with an angular momentum J is written as:

ψ(J)=ΣA_{J}_{_{c}}ⱼΦ(J_{C}, j; J)

Here Φ(J_{c}, j; J) is a state in which the core carries an angular momentum J_{C}, and the odd particle is in the state j.

It is important to note that, formulated in this “core excitation model” way, there is no assumption about the mechanism that leads to the various core-states. These could be collective vibrations, or single particle excitations, or quasi-particle excitations, or anything else. The essential ingredient that goes into this model is the assumption of a weak coupling between the odd particle and the rest of the nucleus. Weak, that is, in comparison with the interactions involved in the core itself.

For a photonuclear reaction in which a species A is converted into a species B (A→B), if the cross-section of this reaction is σ, then nuclei of A are destroyed at a rate of σΦN_{A}, while those of B are produced at this same rate:

R=−dN_{A}/dt=dN_{B}/dt=σΦN_{A}

This equation is of the same form as that for radioactive decay of A to B, but with σΦ, in place of the disintegration constant λ. There is indeed an extensive analogy between the kinetics of a radioactive decay and kinetics in a constant flux of nuclear photons, and the equations concerned are closely similar. If the target species A is radioactive, then both nuclear reaction and decay contribute to its disappearance. The rate of loss is the sum of the two terms:

−dN_{A}/dt=σφN_{A}+λ_{A}N_{A}=(σφ+λ_{A})N_{A}

If φ is constant, there will be a corresponding effective half-life of 0.693/(σΦ+λ_{A}). Again, if the product B is radioactive, and we neglect the loss of B by further nuclear reaction, it will be produced at a net rate:

dN_{B}/dt=σφN_{A}−λ_{B}N_{B}

The application of the invented method toward treating fission waste products is useful in several ways. Fission products of principal concern because of their substantial thermal impact on waste repositories, as opposed to posing health risks, are strontium⁹⁰ and cesium¹³⁷. These two radionuclides are dominant contributors to the heat released by spent fuel at least for the first several decades. Cesium¹³⁷ is also a major source of penetrating radiation emitted by spent fuel. The two fission products of principal concern because of their potential contribution to health risks are technicium⁹⁹ and iodine¹²⁹. They are of principal concern because they are long-lived, produced in significant amounts in the fission process, generally soluble under geologic conditions, and migrate relatively quickly under common ground water conditions. The long-term toxicity of spent fuel is dominated by the actinides such as neptunium²³⁷ , uranium²³⁴, uranium²³⁶, plutonium²³⁹, plutonium²⁴⁰ and plutonium²⁴². However, the long-term risk is dominated in most scenarios by iodine¹²⁹ and technicium⁹⁹ because they are typically water soluble and mobile in groundwater pathways.

Photon transmutation of nuclear waste yields exceptionally high fractional rates for transmuting the transuranic and long-lived fission products. The method of the present invention reduces the transuranic in waste to such an extent that all waste containing residual transuranic will be Class C or less, that is low level waste which is suitable for shallow land burial.

The goal of the invented photon transmutation for waste management purposes is to convert a long-lived radionuclide that is potentially troublesome at a waste disposal site to a shorter-lived or stable nuclide by exposing the troublesome nuclide to a high gamma flux for a sustained time. This has the effect of reducing the long-term toxicity of the waste because most of the waste constituents then decay to a non-radioactive nuclide in a short time.

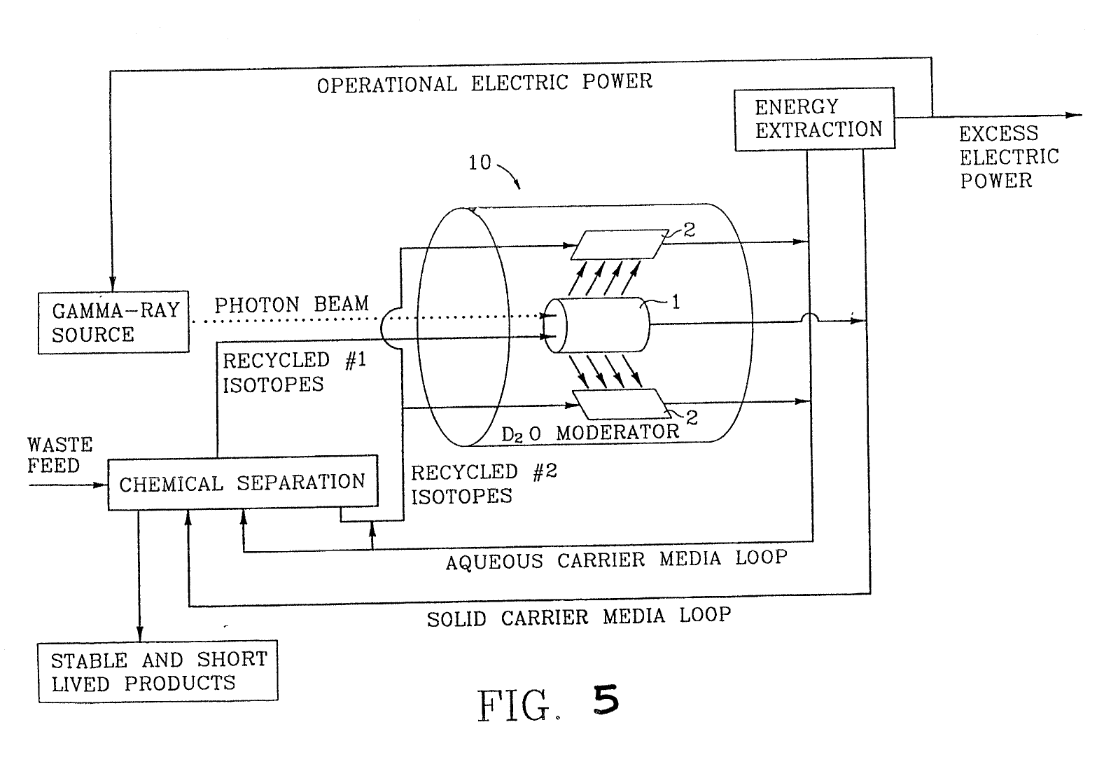

The application of the processes of this invention into a waste treatment facility will provide a boost to the nuclear power industry by providing a cheap, effective method for disposal of reactor waste products. FIG. 5 shows a schematic of one embodiment of a commercial fission-waste transmutation system of the present invention. The various steps and equipment involved are outlined below.

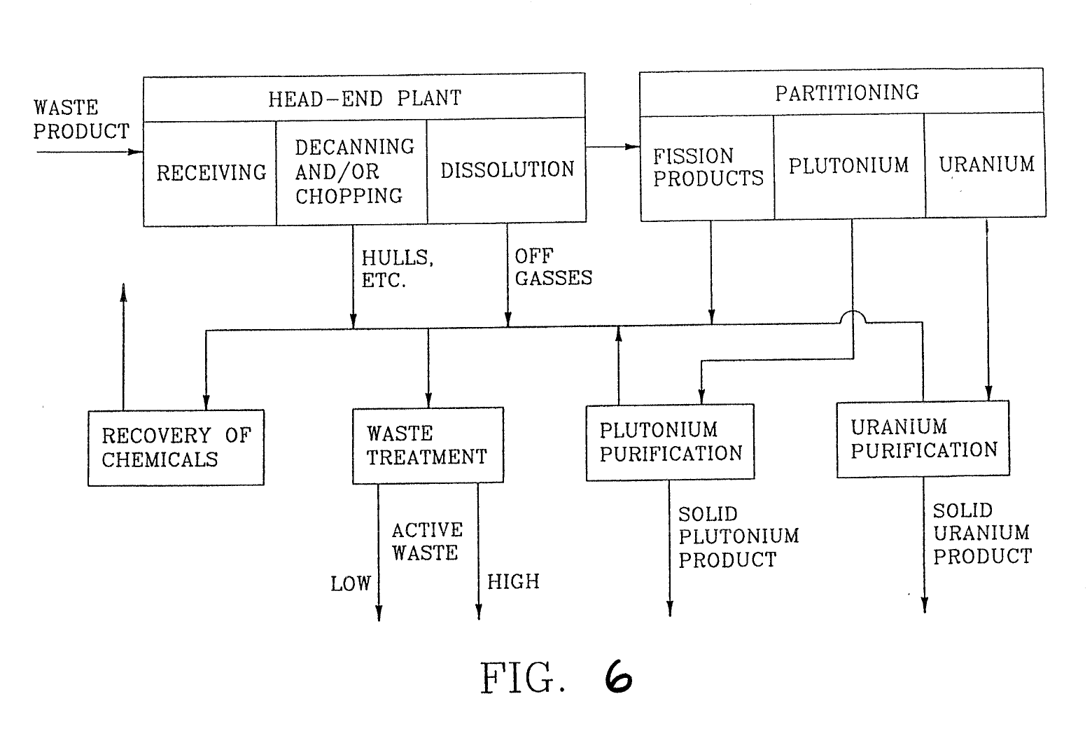

To obtain high purity fractions that can be made into transmutation targets, chemical processes such as those described in the Related Art section are preferably employed to separate the chosen radioactive components from the wastes. FIG. 6 illustrates a detail schematic for a chemical separation section such as may be employed in the overall process flow scheme of FIG. 5. Generally, the operating techniques and conditions for the systems shown in FIG. 6 may be derived from conventional chemical processes.

The preferred commercial waste transmutation facility requires head-end treatment of spent reactor fuel to chop and dissolve the fuel, followed by separation of the transuranic and selected fission products. Either aqueous or non-aqueous processes may be used for the initial separations. The well-established PUREX process may be used for this separations step. This is followed by an aqueous separations process using an advanced technology such as the TRUEX process. A full scale separations system may be designed with high confidence, and present engineering capabilities, for overall separations process losses of less than 0.1%. Solid metals may be separated by pyrochemical processes. Pyrochemical processes may require less capital expense than aqueous processes because the volume of shielded space may be smaller as well as the reduction in the size of the plant and equipment needed.

The radioactive materials to be transmuted are in either an aqueous slurry or in solid form when fed into the system. Some compounds as well as individual atoms may be used as charge for the transmutation system.

After the chemical separation of the radioactive isotopes and containment of the separated radioactive isotopes into a target structure or area, the targets are irradiated in a flux having sufficient intensity and energy such that preferably substantially all of the radionuclides in the targets will either be transmuted or fissioned into stable elements or isotopes with substantially shorter half-lives at an acceptable rate. Many different methods for generating gamma rays can be utilized in the facility of the present invention. The betatron, for one, is very efficient, simple in construction, and compact enough to be portable. The gamma source need produce a beam of gamma rays with an energy greater than the binding energy of the isotope being treated. That is, the preferred photon beam has an adjustable beam energy up to a maximum of about 15 MeV per photon.

The photons utilized in the present invention to initiate photodisintegiation may be generated by an external converter material such as tungsten or titanium (“high-Z target”). Thus, an electron accelerator may supply accelerated electrons to impact the external converter material to supply x-rays or gamma rays Deceleration of electrons converts the kinetic energy of the electron into photons and this process is called “bremstrahlung.” Thus, the combination of an electron accelerator plus a high-Z target is commercially available as an industrial X-ray source.

The photons utilized in the present invention may also be generated internally by directing the electrons directly onto the radioactive target. In this approach, electrons are again converted into photons by bremstrahlung within the first few hundredths of an inch within the radioactive target and these photons in turn travel up to three feet into the target to initiate photodisintegration. The only difference between the two approaches is the presence or absence of an external converter material. By removing the external converter, and instead bombarding the radioactive target directly with electrons, the efficiency of the process would be increased, since it is well known that about 70% of an electron beam energy is lost in a converter in the form of heat. However, in application of the present invention, design and cost considerations could lead to the use of an external converter for simplicity sake.

Therefore, substantially similar apparatus and methods for transmutation can be used for the preferred two groups of embodiments, those in which electrons directly bombard the radioisotopes to initiate photodisintegration, and those in which high-energy photons (produced by electrons hitting a high-Z target) bombard the radioisotopes to initiate photodisintegration The photonuclear reactions within the gamma-bombarded isotope 1 target release neutrons which are then utilized to treat other radioactive waste products by neutron absorption. This neutron flux by-product, on the order of 10¹⁵ n/cm² sec, may be used for activation as well as neutron transmutation of other radioactive waste products, such as:

Tc⁹⁹+n→Tc¹⁰⁰(16second half-life)→β+Ru¹⁰⁰(stable)

I¹²⁹+n→I¹³⁰(12.4hour half-life)→β+Xe¹³⁰(stable)

I¹²⁷+n→I¹²⁸(25minute half-life)→β+Xel¹²⁸(stable)

The waste products treated according to the present invention become heat sources due to their inherently short half-lives. The overall invented process therefore generates heat, which is recovered to produce the power for the gamma source, to be utilized in conversion systems for producing electrical power, to powering the treatment equipment itself, or to produce excess power for sale to the grid.

As schematically depicted in FIG. 5, the radioactive isotopes 1 to be gamma-treated may be confined in a cylindrical area positioned appropriately to be bombarded by the photon beam. Other radioactive waste/isotopes 2 may be positioned as an annular cylinder concentric to the gamma treatment isotopes 1, so that the neutrons emitted by isotopes 1 may bombard the other isotopes 2. For example, charges of gamma treatment radioisotopes 1 and neutron treatment isotopes 2 may be added to a reactor system 10 that receives the gamma radiation (photon beam). For example, the charge of isotopes 1 may be in solid form and added batch-wise to the reactor system 10, and the charge of isotopes 2 may be in aqueous form and added batch-wise to the reactor system 10. After the gamma treatment of isotopes I and the resulting neutron treatment of isotopes 2, the transmuted products may be removed from the reactor system and recycled to the chemical separations plant for separation of the stable and short-lived products from the still-radioactive isotopes that are to be recycled back to the reactor system. Heat from the photon and neutron treatment reactions may be recovered by conventional means to produce electric power.

Various controllers may be utilized to control the photon beam and to control the process in general. Once the invented process and control needs are understood, one skilled in the art of process control may install various systems for efficient operation.

A conventional controller may be used to control the gamma ray flux imparted to the gamma treatment isotopes 1. This may be done by varying/adjusting the beam current within the accelerator.

The transmutation facility may include a control system for controlling the duration of gamma exposure and photodisintegration. For example, the neutron flux from isotopes 1 may be measured to monitor the progress of transmutation. When the neutron flux has dropped to a level indicating that substantial transmutation of isotopes 1 has been completed, the transmuted products may be discharged from the reactor system and recharging may commence. Alternatively, other control systems for controlling duration of gamma exposure are envisioned, such as monitoring the heat evolved in the reactor system. Thus, the duration control system may comprise monitoring the progress of the transmutation process and recharging the reactor system appropriately.

After reading this Description and viewing the drawings, those of skill in the art will understand how, or be able without undo experimentation, to implement the claimed invention, that is, the specifics of construction and operation. As explained above, a source of gamma rays, x-rays, photons, or electrons may be used, with an optional high-Z target for electron conversion to photons. The electron beam, used with or with high-Z target, may be controlled, focused, scanned or manipulated in any suitable manner by control techniques known in the art.

The exact composition of the transmuted material would depend upon the exact composition of the nuclear waste or spent nuclear fuel target, and the exact composition of nuclear waste or spent nuclear fuel target is not needed for one of average skill in this art to understand the invention and, without undo experimentation, to perform the invention. Since such targets (nuclear waste or spent nuclear fuel) are comprised of some 300 isotopes, the resulting products and impurities will be complex. From empirical studies, we can show the product yield of photofission of Uranium²³⁸ and that photodisintegration of these isotopes results in final products consisting of xenon, barium and zirconium, as shown below:

This figure shows the products produced by photofission of Uranium-238 by 10 MeV x-rays. The U²³⁸ itself may be used as both the gamma converter and the target, that is, eliminate a separate electron to gamma converter and use the target material itself as the x-ray source. The advantage here is the recovery of the heat normally dissipated in the converter which is on the order of 70% of the beam energy.

The destruction rate of long-life radioisotopes in the present invention is a function of flux intensity. While the energy level preferably stays in the range of less than about 30 MeV and more preferably about 5-14 MeV, the beam current is a function of the target volume. The equations on page 9 lines 12-26 may be solved for beam flux. For example, beam flux requirement is extrapolated from equations reported earlier in this application, as follows:

BEAM FLUX REQUIREMENTS

Calculations show that efficient (γn) incineration of Cs¹³⁷ and Sr⁹⁰ requires a gamma flux of but only 10¹⁸ γ/cm² sec to accelerate the time of decay by 180 times.

The number of nuclei (γ,n) reacting during the irradiation can be determined by the following differential equation:

$$ⅆ {N}_{i} / ⅆ t = - ( {λ}_{i} + {σ}_{i} φ ) {N}_{i} + {\sum }_{j \neq i}^{{N}_{a}} ( {λ}_{ji} + {σ}_{ji} φ ) {N}_{j} , \qquad ( Eq . 1 )$$

where

Nᵢ=number of the ith nucleus,

λᵢ=decay constant of the ith nucleus,

σᵢ=total photonuclear cross section of the ith nucleus

λⱼᵢ=decay constant from the jth nucleus transmuting to the ith one,

Φ=γ-ray flux,

Nₐ=number of nuclei considered in the model.

Using the matrix representation, eq.(1) is written as follows:

dN/dt=A·N, (Eq. 2)

where

−(λᵢ+σᵢΦ) (i 32 j),

Aⱼᵢ={λⱼᵢ+σⱼᵢΦ(i≠j).

The matrix of the nuclei N at the time t=Δt can be obtained by the Taylor's expansion:

$$N ( t + Δ t ) = N ( t ) + {\sum }_{r = 1} {( Δ t )}^{r} / r ! ⅆ {N}^{( n )} ( t ) / ⅆ t , \qquad ( Eq 3 )$$

where

dN⁽ⁿ⁾(t)/dt is the rth derivative of N(t).

Combining equations (2) and (3), we can obtain N(t+Δt) as follows:

$$N ( t + Δ t ) = N ( t ) + {\sum }_{r = 1} {( Δ t )}^{r} / r ! {A}^{r} N ( t ) . \qquad ( Eq . 4 )$$

The matrix A contains two kinds of data: the decay constants and the photonuclear cross sections.

The mode of operation may be to operate the accelerator in continuous mode, but that is not mandatory, since the invention works also in pulsed mode. Further, multiple accelerators may be arranged in an array for increased flux density or to allow a continuous beam from an array of pulsed accelerators. In any case, continuous operation is preferred, but the mode of operation is not a limiting factor and implementing a mode of operation would be within the skill in the art after the invention is disclosed. The time required to transmute a given material is dependant upon the flux density, geometry, and many other factors, as indicated earlier in this Description and as follows:

One of the important factors for the transmutations study is the transmutation rate. It is expressed as follows,

λ=N ƒσ(Ε)Φ(Ε)dΕ≈NσₐᵥƒΦ(Ε)dΕ

where N is the number of target nuclides, σ(Ε) is the excitation function of the relevant nuclear reaction, Φ(Ε) is the particle flux density, and σₐᵥ is the average cross section. In order to estimate the transmutation rate, it is indispensible to know the accurate excitation function or average cross section.

Shielding, radiation monitoring, calibration, background, etc, may be designed by a nuclear engineer designing equipment for a specific application and the health physicist who must ensure compliance with the ever- changing regulations.

In summary, the important industrial products of the instant reactions are: less dangerous radioactive materials in the long run, produced neutrons, radioactive materials with increased specific activity and increased specific energy, and, depending on the amount of energy imparted to the subject nuclei, also produced protons and alpha particles.

Although this invention has been described above with reference to particular means, materials and embodiments, it is to be understood that the invention is not limited to these disclosed particulars, but extends instead to all equivalents within the scope of the following claims.

I claim:

1.) A nuclear waste remediation process for treating long-lived radioisotopes by transmuting them into short-lived radioisotopes or non-radioactive isotopes, comprising:
1) accelerating electrons in an accelerator;
2) impacting a target of high atomic number with said electrons;
3) generating, on said impact, a flux of giant resonant gamma rays from said target;
4) bombarding nuclei of long-lived radioisotopes with said gamma ray flux, so that a neutron is ejected from said nuclei; and
e) therefore producing a product of short-lived isotopes or non-radioactive isotopes of reduced atomic mass.

2.) The process of claim 1 wherein the long-lived radioisotopes includes radioactive atoms selected from the group consisting of Cs¹³⁷, SR⁹⁰, I¹²⁹, and Tc⁹⁹.

3.) The process of claim 1 wherein said long-lived radioisotopes include radioactive atoms with atomic numbers exceeding 50.

4.) The process of claim 1 wherein the flux of giant resonant gamma rays have an energy of 5-14 MeV.

5.) A method for reducing the long-term toxicity of radioactive waste comprising:
5) using a linear accelerator to accelerate electrons;
6) using said accelerated electrons to impact a high Z target;
7) using said high Z target to generate a flux of giant resonant gamma rays;
8) impacting radioactive waste with said flux of giant resonant gamma rays to eject a neutron from nuclei of radioactive isotopes in said radioactive waste, and producing a product isotope of reduced atomic mass;
wherein long-term toxicity of the radioactive waste is thereby reduced.

6.) The method of claim 5 wherein said radioactive isotopes include radioactive atoms selected from the group consisting of Cs¹³⁷, Sr⁹⁰, I¹²⁹, and Tc⁹⁹.

7.) The method of claim 5 wherein said radioactive isotopes include radioactive atoms with atomic numbers exceeding 50.

8.) A radioactive waste transmutation facility comprising:
1) an accelerator for electron acceleration;
2) a high atomic number target for receiving the impact of accelerated electrons;
3) an adjustable flux controller for controlling the flux of giant resonant gamma rays emerging from said target throughout the duration of said impact;
4) a reactor system for subjecting a quantity of radioactive isotopes to bombardment of the controlled gamma ray flux to eject a neutron from nuclei of said radioactive isotopes by photodisintegration;
5) a duration control system for controlling the duration of photodisintegration and the corresponding transmutation of said radioactive isotopes;
wherein the transmutation facility is thereby adapted to reduce the long-term radioactivity of the radioactive waste.

9. The commercial radioactive waste transmutation facility of claim 8 wherein the radioactive isotopes includes atoms from the group consisting of Cs¹³⁷ , Sr⁹⁰, I¹²⁹, and Tc⁹⁹.

10. The commercial radioactive waste transmutation facility of claim 8 wherein the radioactive isotopes include atoms whose atomic number exceeds 50.

11. The method of claim 5, wherein the flux of giant resonant gamma rays have an energy of 5-14 MeV.

12. The radioactive waste transmutation facility of claim 8, wherein the flux of giant resonant gamma rays have an energy of 5-14 MeV.

13. A nuclear waste remediation process for treating long-lived radioisotopes by transmuting them into short-lived or non-radioactive isotopes, comprising:
accelerating electrons in an accelerator;
providing a long-lived radioisotope;
irradiating said radioisotope with said electrons to produce bremstrahlung photons within said radioisotope, wherein:
said photons react with nuclei of said radioisotope to eject a neutron from said nuclei, thereby producing a short-lived or non-radioactive product of reduced atomic mass.

14. A method for reducing the long-term toxicity of radioactive waste comprising:
using a linear accelerator to accelerate electrons;
using said accelerated electrons to impact radioactive isotopes to generate a flux of giant resonant gamma rays, wherein:
said gamma rays react with the nuclei of said radioactive isotopes to eject a neutron from said nuclei of said radioactive isotopes, thereby producing a product isotope of reduced atomic mass wherein long-term toxicity of the radioactive waste is thereby reduced. A radioactive waste transmutation facility comprising:
a chemical separation plant for separating radioactive isotopes from radioactive waste;
an accelerator for electron acceleration;
a high atomic number target for receiving the impact of accelerated electrons;
an adjustable flux controller for controlling the flux of giant resonant gamma rays emerging from said target throughout the duration of said impact;
a reactor system for subjecting a quantity of said separated radioactive isotopes to bombardment of the controlled gamma ray flux to eject a neutron from nuclei of said separated radioactive isotopes by photodisintegration;
a duration control system for controlling the duration of photodisintegration and the corresponding transmutation of said separated radioactive isotopes;
wherein the transmutation facility is thereby adapted to reduce the long-term radioactivity of the radioactive waste.
